(19) United States
(12) Patent Application Publication
(10) Pub. No.: US 2005/0245269 A1
(43) Pub. Date: Nov. 3, 2005

(54) Channel scanning in wireless networks

(75) Inventors: Mustafa Demirhan, Hillsboro, OR (US); Mousumi Hazra, Beaverton, OR (US); Nandakishore Kushalnagar, Portland, OR (US); Emily H. Qi, Portland, OR (US)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/835,941

(22) Filed: Apr. 30, 2004

(51) Int. Cl. H04Q 7/20

(52) U.S. Cl. 455/452.1; 455/450

(57) ABSTRACT

Channel scanning in a wireless network is performed in a coordinated fashion by access points and mobile stations.

### FIELD

The present invention relates generally to computer networks, and more specifically to wireless networks.

### BACKGROUND

Mobile stations and access points in wireless networks typically communicate using radio frequency (RF) signals. The RF signals may be subject to interference caused by other wireless networks or other types of devices that emit RF signal energy.

### BRIEF DESCRIPTION OF THE DRAWINGS

FIG. 1 shows a diagram of a wireless network;

FIG. 2 shows channels in a communications medium;

FIG. 3 shows a sequence of communications and actions in a wireless network;

FIGS. 4 and 5 show flowcharts in accordance with various embodiments of the present invention; and

FIG. 6 shows a system diagram in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

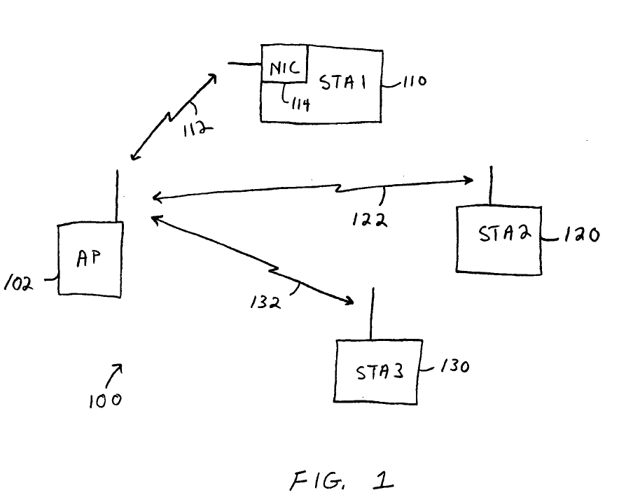

FIG. 1 shows a diagram of a wireless network. Wireless network 100 includes access point (AP) 102 and mobile stations (STA) 110, 120, and 130. In some embodiments, wireless network 100 is a wireless local area network (WLAN). For example, one or more of mobile stations 110, 120, and 130, or access point 102 may operate in compliance with a wireless network standard such as ANSI/IEEE Std. 802.11, 1999 Edition, although this is not a limitation of the present invention. As used herein, the term “802.11” refers to any past, present, or future IEEE 802.11 standard, including, but not limited to, the 1999 edition.

Mobile stations 110, 120, and 130 may be any type of mobile station capable of communicating in network 100. For example, the mobile stations may be computers, personal digital assistants, wireless-capable cellular phones, or the like. As explained below, in some embodiments, mobile stations 110, 120, and 130 operate in compliance with an 802.11 standard, and are also capable of scanning channels to detect interference. The channel scanning may occur simultaneously with channel scanning performed by access point 102, or may be performed at periodic intervals whether or not access point 102 performs channel scanning.

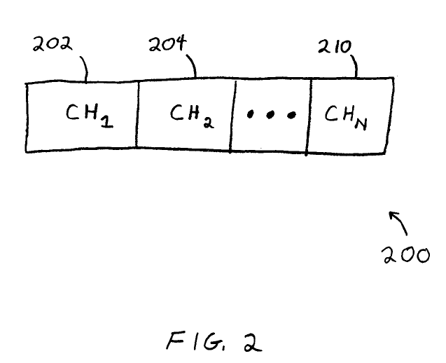

Access point 102 communicates with mobile station 10 (also referred to as “STA1”) using signal 112. Access point 102 communicates with mobile station 120 (also referred to as “STA2”) using signal 122, and access point 102 communicates with mobile station 130 (also referred to as “STA3”) using signal 132. In some embodiments, signals 112, 122, and 132 utilize one out of many possible “channels.” For example, wireless network 100 may operate in a single channel, and signals 112, 122, and 132 are all signals in the single channel. This single channel is referred to herein as the “channel in use” by wireless network 100. The channel in use by network 100 may be subject to interference by other wireless networks or other RF emitters. Other channels available to wireless network 100 may also be subject to interference. In some embodiments, wireless network 100 may change the channel in use to any channel available to network 100. Channels are discussed in more detail below with reference to FIG. 2.

Mobile station 110 includes network interface card (NIC) 114. In some embodiments, mobile station 110 may be a computer such as a notebook computer or a desktop computer that includes NIC 114. Mobile stations 120 and 130 are shown without NICs. In some embodiments, mobile stations 120 and 130 may be wireless devices that have built-in wireless capability. For example, mobile station 120 may be a notebook computer having a chipset with built-in wireless connectivity capability.

FIG. 2 shows channels in a communications medium. A communications medium may include any number of channels, and the channels may be defined in many different ways. As used herein, the term “channel” refers to any subset of a communication medium that may be used for a communication in a wireless network. For example, in some frequency division multiplexing embodiments, channels may be defined by a frequency band. Also for example, in some spread spectrum embodiments, channels may be defined by codes used to specify the spreading of the signal. In still further embodiments, channels may be defined using a combination of spatial information and other information, such as in systems that utilize spatial division multiple access (SDMA) or multiple-input-multiple-output (MIMO) communications. Channels may be defined in any manner without departing from the scope of the present invention. Channels 200 are shown in FIG. 2 as including “N” possible channels, although any number of channels may be present.

Wireless networks may use any available channel. For example, signals 112, 122, and 132 in wireless network 100 (FIG. 1) may use channel 202, channel 204, channel 210, or any other channel in channels 200. Other wireless networks or RF emitters may also use one or more channels available to wireless network 100, resulting in interference. In various embodiments of the present invention, access points and mobile stations perform channel “scans” to detect potential interference. As used herein the term “scan” refers to an act of monitoring one or more channels to detect potentially interfering signals. In some embodiments, channel scanning is performed by both an access point and one or more mobile stations in a coordinated fashion. For example, an access point may scan one channel, while a mobile station simultaneously scans a different channel.

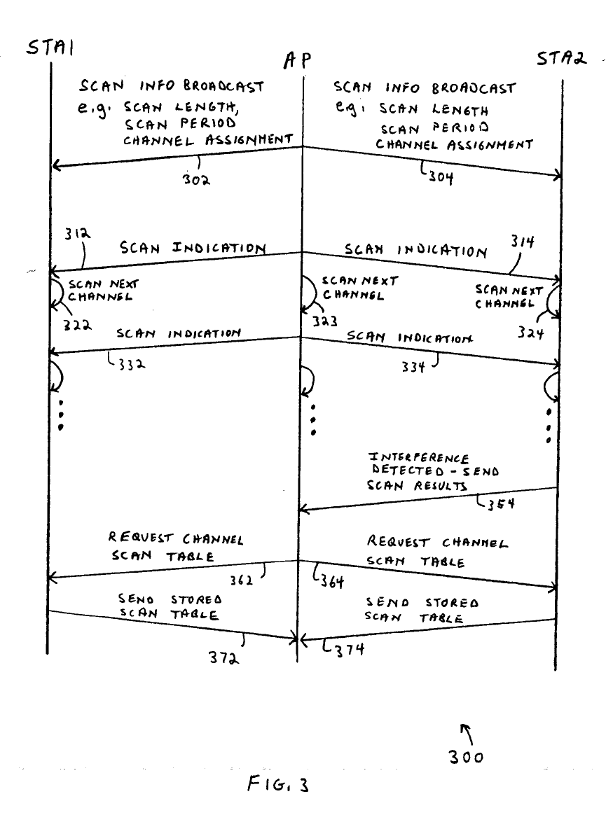

FIG. 3 shows a sequence of communications and actions in a wireless network. Sequence 300 includes communications between an access point and mobile stations such as access point 102 and mobile stations 110 and 120 (FIG. 1). As shown in FIG. 3, time progresses from the top of sequence 300 to the bottom of sequence 300. During sequence 300, the access point and mobile stations are collaboratively responsible for scanning channels for interference. Channels are scanned periodically, and one or more tables of channel interference, or “scan tables,” are maintained to track which channels are subject to interference. For example, as described more fully below, in some embodiments, each device in the network (e.g., access points and mobile stations) may maintain a single scan table, and an access point may obtain scan tables or parts thereof from mobile stations.

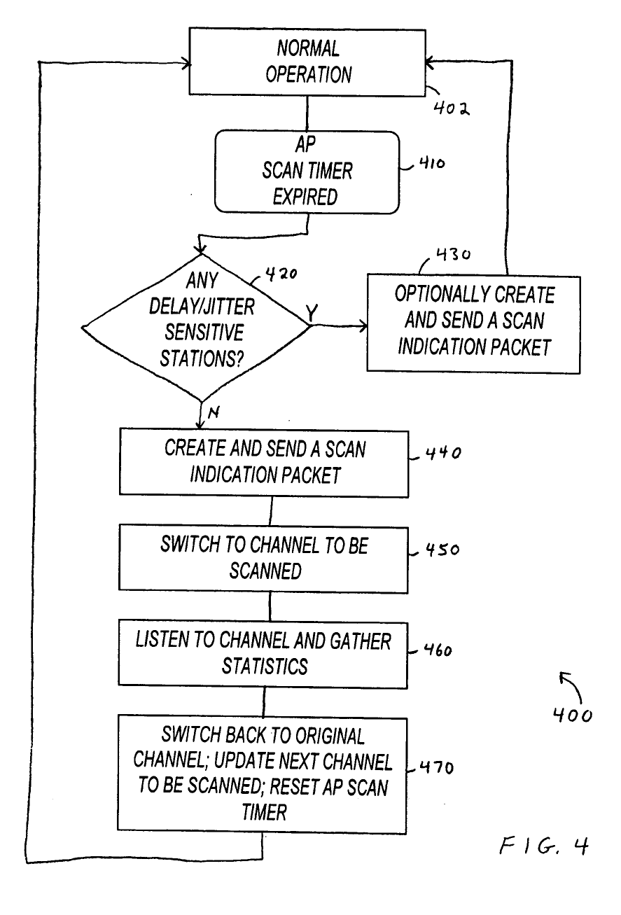

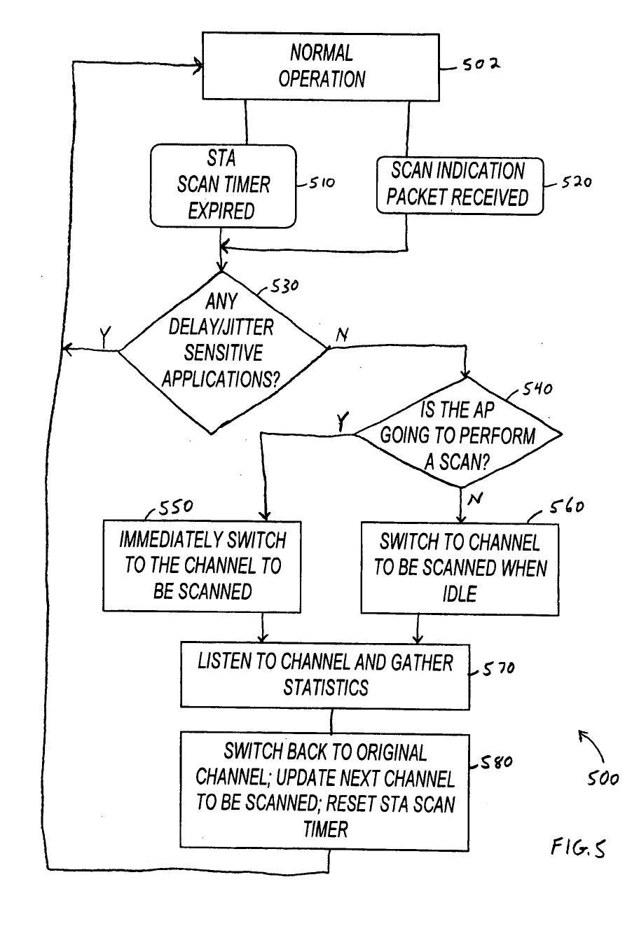

Sequence 300 shows various embodiments of interaction between an access point and mobile stations. These interactions are also further described below with reference to FIGS. 4 and 5 which show flowcharts of methods performed by an access point and a mobile station, respectively.

At the top of sequence 300, the access point broadcasts general scan information to any mobile stations within range. For example, the AP broadcasts general scan information to STA1 at 302 and to STA2 at 304. This general scan information may be broadcast to mobile stations during or after the association phase of each mobile station. The general scan information may be broadcast in packets, frames, or the like.

General scan information broadcasts may include many parameters. For example, general scan information broadcasts may include parameters such as a scan length, a channel scan period, initial channel assignments for each mobile station to scan, and a rule for determining a next channel to scan. Further, an access point may optionally assign the first channel to be scanned by each mobile station. By assigning a first channel to scan, the access point may ensure that each mobile station scans a different channel in each scan period or that all channels are scanned in the least amount of time. In some embodiments, the first channel assignment is not provided, and the mobile station may choose the first channel to be scanned, either randomly or according to a predetermined algorithm.

The channel scan period and the channel scan length may be set to any appropriate values. For example, in some embodiments, the channel scan period may be set to between 10 and 15 seconds, so that mobile stations will perform channel scans every 10 to 15 seconds if the access point does not initiate a channel scan sooner. Also for example, a channel scan length may be set to a few hundred milliseconds. In some embodiments, the channel scan length may be set based in part on the expected interference. For example, a channel scan length may be set to 200 milliseconds in an effort to detect interfering 802.11 networks with a beacon interval of 100 milliseconds. The values for periods and lengths just described are provided as examples only, and the various embodiments of the present invention are not limited in this regard.

When broadcasting general scan information, the access point may also specify a rule for the mobile stations to determine a next channel to scan. For example, the access point may specify that mobile stations are to increment a channel number after performing a channel scan, and the incremented channel number will specify the next channel to be scanned. In these embodiments, each mobile station scans a sequential block of channels over time. Also for example, the access point may specify that mobile stations are to compute a next channel to be scanned using a more complex algorithm, such as adding an offset other than one, or looking up a next channel assignment in a table.

The broadcast of general scan information just described determines a default scanning environment. Under the default scanning environment, mobile stations perform a channel scan once for each scan period, where the channel to be scanned is determined by information provided in the general scan information broadcast. In some embodiments, mobile stations set a timer (referred to herein as a “mobile station scan timer”) using the scan period received from the access point. When the mobile station scan timer expires, the mobile station performs a channel scan according to the received general scan information.

The default scanning environment may be overridden by the access point. The access point may send a “scan indication” to one or more mobile stations to explicitly override the default scanning environment, and to cause an immediate channel scan, subject to certain conditions. Scan indications may be sent using any suitable mechanism such as frames, packets or the like. Scan indications are described in the remainder of this description as scan indication packets, although this terminology is not meant to limit the various embodiments of the invention. In some embodiments, an access point may send scan indication packets just prior to the end of a scan period to control each channel scan, and in other embodiments, an access point may not send scan indication packets, and mobile stations may perform channel scans according to the default scanning environment.

In some embodiments, an access point may send a scan indication packet to inform the mobile stations that the access point will perform a channel scan just after the transmission of that packet is complete. A mobile station that receives the scan indication packet may then perform its own channel scanning task immediately after the reception of the packet. This ensures that the mobile station scans coincide with that of the access point and thereby reduces the possibility of disruption of service as a result of performing channel scans.

In some embodiments, an access point may include a scan timer which, upon expiration, may cause the access point to send a scan indication packet. For example, in some embodiments, an access point may set an access point scan timer to a value that is smaller than the scan period broadcast in the general scan information. When the access point scan timer expires, the access point may send a scan indication packet to initiate scanning.

Examples of an access point sending channel scan indication packets are shown at 312 and 314. The access point is shown sending a scan indication packet to STA1 at 312 and sending a scan indication packet to STA2 at 314. In some embodiments, 312 and 314 represent a single scan indication packet broadcast by the access point and received by both STA1 and STA2. In response to the scan indication packet, the access point and both mobile stations of FIG. 3 perform a channel scan. A channel scan is performed by STA1 at 322; a channel scan is performed by STA2 at 324; and a channel scan is performed by the access point at 323.

The access point is also shown sending channel scan indication packets at 332 and 334. Sequence 300 shows channel scans occurring at two different times in response to scan indication packets being sent twice by the access point. Any number of scan indication packets may be sent, and they may be periodic or non-periodic.

During each channel scan, each device (APs and STAs) may change its receiver channel, listen to that channel, return the original channel, update the next channel to be scanned, and reset a scan timer. When a device changes its receiver channel to the channel that it is responsible to scan, it may change to a channel that is specified in a scan indication packet, or it may change to a channel that was determined as the next channel to be scanned using a rule specified by the access point.

During the channel scan, a device may listen to a channel for a fixed amount time as specified by the access point. For example, the device may listen to the channel for a period of time equal to the scan length as specified by the access point in the broadcast of general scan information. Also for example, a mobile station may listen to the channel for a period of time which is provided to the device by the access point during the association of that mobile station. During the listening period, devices may extract useful information from beacons and packets that they can hear. Apart from listening to wireless network sources, devices may also log signal to noise ratio (SNR) information on that channel in order to detect non-wireless network interference sources such as microwave, cordless phones, etc.

After the listening period ends, the device returns back to its original channel and resumes operating on that channel, and it updates the channel to be scanned in the next scan period. Updates may be performed by incrementing the last scanned channel number in a round-robin fashion, or may be performed according to a rule provided by the access point. The device may also reset a scan timer. For example, a mobile station may reset a mobile station timer to the scan period received in the broadcast from the access point. Also for example, an access point may reset an AP scan timer to a value less than the scan period.

In some embodiments, mobile stations store the information collected during the channel scan and report back to the access point only when new interference sources are detected. For example, as shown in sequence 300, STA2 detects interference and sends scan results to the access point at 354. By only sending scan results when interference is detected, bandwidth between the access point and mobile stations may be conserved, and may also allow an access point to become aware of interference sources that are seen by mobile stations and not by itself. Also in some embodiments, mobile stations only report back to the access point when information collected differs from previously collected data. For example, a mobile station may detect interference in a channel that had previously been logged as having interference present. In this example, the mobile station may not report that the interference was found, in part because the access point already has information describing the interference in the channel.

In some embodiments, an access point may send a request for results of a previous scan, or may request all of the scan information collected by a mobile station. In some embodiments, the scan information is maintained in a scan table at the mobile station. As shown in sequence 300, the access point requests a scan table from STA1 at 362, and receives a response from STA1 at 372. Also as shown in sequence 300, the access point requests a scan table from STA2 at 364, and receives a response from STA2 at 374. An access point may request a scan table for many different reasons. For example, in some embodiments, an access point may request a scan table when it detects interference in its current operating channel in order to determine a new operating channel. Further, if a mobile station detects interference sources on the current operating channel, it may send the scan table to the access point without being requested to do so.

FIG. 4 shows a flowchart in accordance with various embodiments of the present invention. In some embodiments, method 400 describes the operation of an access point in a wireless network. In some embodiments, method 400, or portions thereof, is performed by an access point, a network interface card, a processor, or an electronic system, embodiments of which are shown in the various figures. Method 400 is not limited by the particular type of apparatus, software element, or system performing the method. The various actions in method 400 may be performed in the order presented, or may be performed in a different order. Further, in some embodiments, some actions listed in FIG. 4 are omitted from method 400.

Method 400 is shown beginning at block 402 in which an access point is in normal operation. As used herein, the term “normal operation” refers to operations other than channel scanning performed by an access point or mobile station. As described above, access points may include an AP scan timer that is set to time out prior to the end of the scan period as defined in the broadcast of general scan information. If the AP scan timer has not expired, the access point stays in normal operation, and if the AP scan timer has expired, then method 400 transitions out of normal operation at 410, and checks to determine if any currently associated stations are sensitive to delay or jitter at 420.

A mobile station may be sensitive to delay or jitter if it is running certain types of applications. For example, in some embodiments, a delay or jitter sensitive application may be an application such as voice over IP (VoIP) or any application with quality of service (QoS) guarantees. If there are any delay or jitter sensitive mobile stations, then the access point performing method 400 will optionally create a scan indication packet at 430, and return to normal operation without performing a channel scan. In these embodiments, the access point does not perform a channel scan in part because changing channels to perform a channel scan may impact the delay/jitter sensitive station.

At 430, a scan indication packet is optionally sent. If the scan indication packet is sent, one or more mobile stations may perform a channel scan in response as described above with reference to FIG. 3. In contrast to FIG. 3, however, the access point will transition from 430 to 402 without performing a channel scan. If a scan indication packet is not sent at 430, one or mobile stations may still perform a channel scan as a result of mobile station timers expiring in the individual mobile stations.

If method 400 determines that there are no delay/jitter sensitive stations, then a scan indication packet is created and sent at 440. In some embodiments, the scan indication packet sent at 440 specifies that the mobile stations should perform a channel scan immediately after receiving the packet, or at a time coordinated with the access point. In this manner, the access point and the mobile stations may perform simultaneous channel scans.

At 450, the access point switches to the channel to be scanned, and at 460, the access point listens to the channel and gathers statistics. The gathered statistics may include, but are not limited to, the channel number, the strength of any signal found, and any other information of interest. For example, if a wireless network such as an 802.11 network is detected in the channel, the number of detected beacons or packets may be recorded, as well information included within beacons or packets. The various embodiments of the present invention are not limited with respect to the amount or type of information collected.

At any point in method 400, an access point may request scan results or other scan information from mobile stations to which it is connected. For example, an access point may request scan information from all connected mobile stations when the access point detects interference in the current operating channel, or in any other channel. Also for example, an access point may request mobile stations to report scan results after each scan or only when a scan results in information that is different from a previous scan.

FIG. 5 shows a flowchart in accordance with various embodiments of the present invention. In some embodiments, method 500 describes the operation of a mobile station in a wireless network. In some embodiments, method 500, or portions thereof, is performed by a mobile station, a network interface card, a processor, or an electronic system, embodiments of which are shown in the various figures. Method 500 is not limited by the particular type of apparatus, software element, or system performing the method. The various actions in method 500 may be performed in the order presented, or may be performed in a different order. Further, in some embodiments, some actions listed in FIG. 5 are omitted from method 500.

Method 500 is shown beginning at block 502 in which the mobile station is in normal operation. As described above, mobile stations may include a STA scan timer that is set to time out at the end of the scan period as defined in the broadcast of general scan information. If the STA scan timer expires, then a scan period has ended, and the mobile station will transition out of normal operation at 510 and continue with method 500 to determine whether to perform a channel scan and when. If a scan indication packet has been received, then an access point has initiated a scanning operation and the mobile station will transition out of normal operation at 520 to determine whether to perform a channel scan and when. If the STA scan timer has not expired, and a scan indication packet has not been received, then method 500 remains in normal operation.

If the STA scan timer has expired or if a scan indication packet has been received, then method 500 checks to determine if the mobile station is running any delay or jitter sensitive applications. For example, in some embodiments, a delay or jitter sensitive application may be an application such as voice over IP (VoIP) or any application with quality of service (QoS) guarantees. If there are any delay or jitter sensitive applications running, then in some embodiments, the mobile station will return to normal operation without performing a channel scan. In these embodiments, the mobile station does not perform a channel scan in part because changing channels to perform a channel scan may impact the delay/jitter sensitive application.

At 540, method 500 determines whether the access point is going to perform a channel scan. This determination may be made in many ways. For example, if a scan indication packet was received at 520, the scan indication packet may include information describing which mobile stations are to perform channel scans as well as whether the access point is going to perform a channel scan. Also for example, if the STA scan timer has expired, the mobile station may be configured to assume that either the access point will or will not perform a channel scan.

If the access point is to perform a channel scan, in some embodiments, method 500 immediately switches to the channel to be scanned at 550. By switching channels immediately, the mobile station and access point may coordinate their channel scanning operations in time so as to reduce interruptions in communications between the access point and mobile stations during channel scanning operations. If the access point is not to perform a channel scan, method 500 may switch to the channel to be scanned when desired. For example, a mobile station performing method 500 may switch channels when the mobile station is idle, or when wireless network traffic is reduced, in order to reduce the impact of changing channels to perform a channel scan.

At 570, the mobile station listens to the channel and gathers statistics. The gathered statistics may include, but are not limited to, the channel number, the strength of any signal found, and any other information of interest. For example, if a wireless network such as an 802.11 network is detected in the channel, the number of detected beacons or packets may be recorded, as well information included within beacons or packets. Information within the beacons or packets may include a network identifier such as a service set identifier (SSID) or basic service set identifier (BSSID), or throughput information. The various embodiments of the present invention are not limited with respect to the amount or type of information collected.

At any time during method 500, including during normal operation at 502, an apparatus performing method 500 may send channel scanning information to an access point. For example, a mobile station performing method 500 may maintain a scan table that includes information describing channels that have been scanned and any signals found in the scanned channels. The mobile station may send information describing all of, or any part of, the scan table to an access point, either spontaneously, or in response to a request made by the access point.

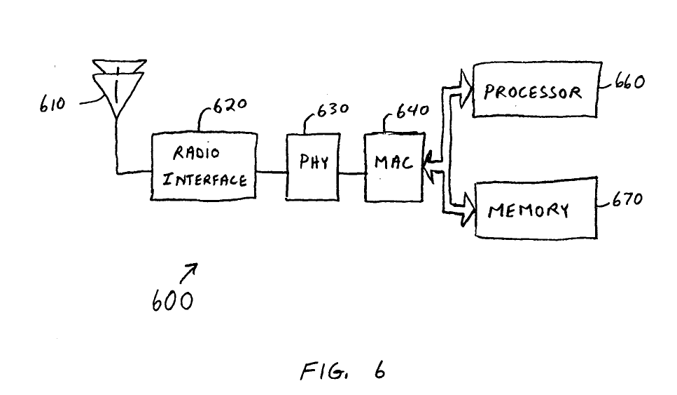

FIG. 6 shows a system diagram in accordance with various embodiments of the present invention. Electronic system 600 includes antennas 610, radio interface 620, physical layer (PHY) 630, media access control (MAC) mechanism 640, processor 660, and memory 670. In some embodiments, electronic system 600 may be an access point, a mobile station, a wireless interface, a NIC, or the like. For example, electronic system 600 may be utilized in network 100 as any of access point 102, mobile stations 110, 120, or 130, or NIC 114. Also for example, electronic system 600 may be an apparatus capable of performing any of the method embodiments described with reference to the previous figures.

In some embodiments, electronic system 600 may represent a system that includes a wireless interface as well as other circuits. For example, in some embodiments, electronic system 600 may be a computer, such as a personal computer, a workstation, or the like, that includes a wireless interface as a peripheral or as an integrated unit.

In operation, system 600 sends and receives signals using antennas 610, and the signals are processed by the various elements shown in FIG. 6. Antennas 610 may include one or more directional antennas or one or more omni-directional antennas. As used herein, the term omni-directional antenna refers to any antenna having a substantially uniform pattern in at least one plane. For example, in some embodiments, antennas 610 may include an omni-directional antenna such as a dipole antenna, or a quarter wave antenna. Also for example, in some embodiments, antennas 610 may include a directional antenna such as a parabolic dish antenna or a Yagi antenna. In some embodiments, antennas 610 form an array capable of supporting spatial division multiple access (SDMA) or multiple-input multiple output (MIMO) communications. In other embodiments, antennas 610 include only one physical antenna.

Radio interface 620 is coupled to antennas 610 to interact with a wireless network. Radio interface 620 may include circuitry to support the transmission and reception of radio frequency (RF) signals. For example, in some embodiments, radio interface 620 includes an RF receiver to receive signals and perform “front end” processing such as low noise amplification (LNA), filtering, frequency conversion or the like. Further, in some embodiments, radio interface 620 includes beamforming circuitry to support SDMA processing. Also for example, in some embodiments, radio interface 620 includes circuits to support frequency up-conversion, and an RF transmitter. The various embodiments of the invention are not limited by the contents or function of radio interface 620.

Physical layer (PHY) 630 may be any suitable physical layer implementation. For example, PHY 630 may be a circuit block that implements a physical layer that complies with an IEEE 802.11 standard or other standard. Examples include, but are not limited to, direct sequence spread spectrum (DSSS), frequency hopping spread spectrum (FHSS), and orthogonal frequency division multiplexing (OFDM). In some embodiments, PHY 630 and radio interface 620 are combined into a single unit.

Media access control (MAC) mechanism 640 may be any suitable media access control layer implementation. For example, MAC 640 may be implemented in software, or hardware or any combination thereof. In some embodiments, a portion of MAC 640 may be implemented in hardware, and a portion may be implemented in software that is executed by processor 660. Further, MAC 640 may include a processor separate from processor 660.

Processor 660 may perform method embodiments of the present invention, such as method 400 (FIG. 4) or method 500 (FIG. 5), or methods represented by sequence 300 (FIG. 3). Processor 660 represents any type of processor, including but not limited to, a microprocessor, a digital signal processor, a microcontroller, or the like.

Memory 670 represents an article that includes a machine readable medium. For example, memory 670 represents a random access memory (RAM), dynamic random access memory (DRAM), static random access memory (SRAM), read only memory (ROM), flash memory, or any other type of article that includes a medium readable by processor 660. Memory 670 may store instructions for performing the execution of the various method embodiments of the present invention.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method comprising:
sending a channel scan indication to a mobile station in a wireless network; and
performing a channel scan.

2. The method of claim 1 further comprising requesting scan results from the mobile station.

3. The method of claim 1 further comprising receiving scan results from the mobile station.

4. The method of claim 1 further comprising prior to sending a channel scan indication, broadcasting general channel scan information.

5. The method of claim 4 wherein broadcasting general channel scan information comprises sending a broadcast packet with a scan period.

6. The method of claim 5 wherein sending a channel scan indication comprises sending a channel scan indication prior to an end of the scan period.

7. The method of claim 4 wherein broadcasting general channel scan information comprises sending the initial channel assignments for each mobile station to scan, and a rule for determining a next channel to scan.

8. The method of claim 4 wherein broadcasting general channel scan information comprises instructing the mobile stations to choose the first channel to be scanned, either randomly or according to a predetermined algorithm.

9. The method of claim 4 wherein broadcasting general channel scan information comprises sending a broadcast packet with a scan length.

10. The method of claim 9 wherein performing a channel scan comprises performing the channel scan for a time substantially equal to the scan length.

11. The method of claim 10 wherein the method is performed by an 802.11 compliant access point.

12. A method comprising:
receiving scan information broadcast by an access point in a wireless network;
setting a scan timer; and
if the scan timer expires, performing a channel scan.

13. The method of claim 12 wherein receiving scan information comprises receiving a scan period.

14. The method of claim 13 further comprising setting the scan timer to the scan period.

15. The method of claim 12 further comprising if a scan indication is received prior to the scan timer expiring, performing a channel scan in response to the scan indication.

16. The method of claim 12 further comprising if a delay sensitive application is running, skipping the channel scan.

17. The method of claim 12 wherein receiving scan information comprises receiving a scan length.

18. The method of claim 17 wherein performing a channel scan comprises listening in a channel for a time substantially equal to the scan length.

19. The method of claim 18 further comprising reporting scan results to the access point only if the channel scan results are different from previous channel scan results.

20. The method of claim 12 wherein receiving scan information comprises receiving a rule specifying how to select a channel to be scanned.

21. The method of claim 20 further comprising selecting the channel to be scanned in accordance with the rule.

22. The method of claim 21 wherein the method is performed by an 802.11 compliant mobile station.

23. An apparatus having a machine-readable medium with instructions stored thereon that when accessed result in a machine performing a channel scan simultaneously with a channel scan performed by an access point in a wireless network.

24. The apparatus of claim 23 wherein the machine-readable medium further includes instructions stored thereon that when accessed result in the machine maintaining a table of channel interference.

25. The apparatus of claim 24 wherein the machine-readable medium further includes instructions stored thereon that when accessed result in the machine transmitting channel scan results when different from data in the table of channel interference.

26. The apparatus of claim 23 wherein the machine-readable medium further includes instructions stored thereon that when accessed result in the machine determining a next channel to be scanned.

27. An electronic system comprising:
a plurality of antennas;
a radio interface coupled to the plurality of antennas;
a processor coupled to the radio interface; and
a memory device with instructions stored thereon that when accessed, result in the processor performing providing a channel scan indication to one or more mobile stations in a wireless network, and performing a channel scan simultaneously with the one or more mobile stations.

28. The electronic system of claim 27 wherein performing a channel scan comprises changing to a channel to be scanned.

29. The electronic system of claim 27 wherein the memory device further includes instructions stored thereon that when accessed result in the processor determining a next channel to be scanned.
